(19) United States
(12) Patent Application Publication
(10) Pub. No.: US 2017/0307494 A1
(43) Pub. Date: Oct. 26, 2017

(54) METHOD FOR DETERMINING THE WORN SHAPE OF A DEFORMABLE BODY

(71) Applicant: The Gillette Company, Boston, MA (US)

(72) Inventors: Javit Ahmed Drake, Jamaica Plain, MA (US); Alison Fiona Stephens, Berkshire (GB); Daniel Christopher Sutton, Stevenage (GB); Georges Roger Jean Limbert, Southampton (GB)

(21) Appl. No.: 15/133,265

(22) Filed: Apr. 20, 2016

(51) Int. Cl. G01N 3/56

(52) U.S. Cl. CPC G01N 3/56

(57) ABSTRACT

The invention features a method for determining the worn shape of a deformable body in sliding contact with a deformable substrate. A wear depth w in an inward normal direction is determined at select points on a surface of the deformable body at each point in time t by integration of the following equation:

$$\frac{dw}{d τ} = {kT}_{n} {v}^{b}$$

where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant determined by physical tests, and τ=t^{b} is a computational time.

### FIELD OF THE INVENTION

The present invention relates to a method for determining the worn shape of a deformable body. Particularly, the present invention relates to a virtual method for determining the worn shape of a deformable body.

### BACKGROUND OF THE INVENTION

A razor cartridge may contain a lubricating member such as a solid, semi-solid or gel lubricating member. An example of such a lubricating member is a lubricating strip made of a high molecular weight polyethylene oxide and high impact polystyrene. The high impact polystyrene serves as the supporting structure for the lubricating strip and the high molecular weight polyethylene oxide serves as the lubricating component. During shaving the lubricating member undergoes abrasive wear as it slides across the skin. Further, leachable and water soluble components of the lubricating member are consumed during use which can also impact the size and shape of the lubricating member. Understanding the wear of the lubricating member is important as the shape change of the lubricating member through the life span of the lubricating member influences a user experience of a razor cartridge.

Effort and resources are needed to optimize the geometry and formulation of a lubricating member in a new razor cartridge design or to improve the geometry and formulation in an existing razor cartridge. To optimize the geometry and formulation one typically performs a series of repeated physical tests to determine how the lubricating member changes shape as it wears by sliding across skin or a skin-like substrate. This iterative physical testing can take a large amount of time depending upon the extent of change or improvement desired and the number of designs and formulations under consideration. In addition, there is a cost component associated with such iterative physical testing.

A virtual modeling technique is needed which provides a method for determining the worn shape of lubricating members prior to undertaking any physical construction of the lubricating member. In particular, the ability to determine the shape change and wear rate of the lubricating member as a function of time provides insights and learnings over models that do not account for shape change over time.

### SUMMARY OF THE INVENTION

The invention is directed to a method for determining the worn shape of a deformable body in sliding contact with a deformable substrate comprising: determining a wear depth w in an inward normal direction at select points on a surface of the deformable body at each point in time t by integration of the following equation:

$$\frac{dw}{d τ} = {kT}_{n} {v}^{b}$$

where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant, and τ=t^{b} is a computational time.

Computer software may be used to determine the worn shape of the deformable body.

For mass loss data {Mᵢ}, i=1, . . . , n, observed at time {tᵢ}, i=1, . . . , n, the material variable k and constant b are determined by minimization of the sum of squared residuals, SSR, between the mass loss data Mᵢ and the predicted mass loss mᵢ with respect to the constants to be determined wherein

$${m}_{i} = ρ {kN ( {vt}_{i} )}^{b}$$

$$SSR = {\sum }_{i = 1}^{n} {( {M}_{i} - {m}_{i} )}^{2}$$

and ρ is the density of the deformable body. The material variable k may be a constant to be determined, or a prescribed function of the formulation of the deformable body with constants to be determined.

The deformable substrate may comprise an abrasive substrate such as felt, a human skin-like substrate, or a substrate of human skin.

The deformable body may comprise a lubricating member on a razor cartridge.

The material dependent variable k may be a function of the process used in making the lubricating member. The material dependent variable k may be a function of the process conditions used in making the lubricating member. The material dependent variable k may be a function of the chemical formulation of the lubricating member.

The sliding contact may be a finite or infinitesimal sliding contact.

The invention is directed to a method for selecting a deformable body to be inserted into a razor blade cartridge. The method comprises the steps of:
a. selecting a desirable wear rate value for the deformable body,
b. providing a first deformable body,
c. providing a second deformable body different from the first deformable body,
d. determining a wear rate value over a defined period of time of the first deformable body and the second deformable body according to the following method:
   i. determining a wear depth w in an inward normal direction at select points on a surface of the deformable body at each point in time t by integration of the following equation:

$$\frac{dw}{d τ} = {kT}_{n} {v}^{b}$$

where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant, and τ=t^{b} is a computational time,
e. selecting the deformable body from either the first deformable body or the second deformable body having the wear rate value closest to the desirable wear rate value.

After selection, the deformable body is secured on a razor cartridge. The deformable body may be secured on the razor cartridge with an adhesive or by mechanical securement, or both.

Computer software may be used to determine the wear rate value of the first and second deformable body.

For mass loss data {Mᵢ}, i=1, . . . , n, observed at time {tᵢ}, i=1, . . . , n, the material variable k and constant b are determined by minimization of the sum of squared residuals, SSR, between the mass loss data Mᵢ and the predicted mass loss mᵢ with respect to the constants to be determined wherein

$${m}_{i} = ρ {kN ( {vt}_{i} )}^{b}$$

$$SSR = {\sum }_{i = 1}^{n} {( {M}_{i} - {m}_{i} )}^{2}$$

and ρ is the density of the deformable body.

The deformable substrate may comprise an abrasive felt, a human skin-like substrate, or a substrate of human skin.

The material dependent variable k may be a function of the process used in making the lubricating member.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is an illustration of a razor cartridge.

FIG. 2 is an illustration of a lubricating member on a wear substrate.

FIG. 3 is a plot of predicted mass loss plotted against sliding distance, compared to the mass loss dataset.

FIG. 4 is a plot of the residuals (between the model predictions and the raw data) plotted against the model predictions.

FIG. 5 is a plot of model prediction of mass loss plotted against sliding distance; (left) various X₁ with X₃=3.0, and (right) various X₃ with X₁=30.

FIG. 6 is a plot of the model prediction of maximum wear depth plotted against mass loss.

FIG. 7 is a plot of predicted maximum wear depth plotted against sliding distance.

### DETAILED DESCRIPTION OF THE INVENTION

As mentioned above, there is a need for a virtual wear modeling technique to determine the wear over time of lubricating members on razor cartridges to avoid the drawbacks associated with physical testing of such lubricating members. Physical testing of lubricating members involves repeated tests to determine how the lubricating member changes shape as it wears by sliding across the skin or a skin-like substrate.

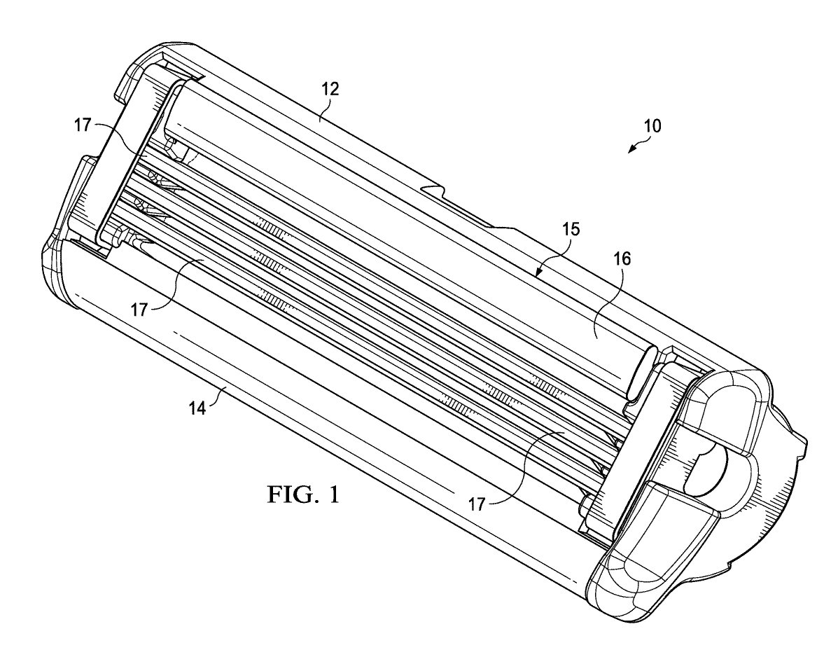

Referring now to FIG. 1 there is shown a razor cartridge 10. Razor cartridge 10 comprises a housing 12. Housing 12 comprises a guard 14 at the front of the housing 12 and a cap 15 at the back of the housing 12. Cap 15 includes a lubricating member 16. Blades 17 are positioned between guard 14 and cap 15.

A lubricating member can be comprised of any solid chemistry on a razor cartridge and is often referred to as a shaving aid. The shaving aid on a razor cartridge is often in the form of a strip and is referred to as a lubrastrip. Lubrastrips are typically in the form of a water insoluble structurant or matrix polymer such as ethylene-vinyl acetate (EVA) or high impact polystyrene (HIPS) and a water soluble lubricant such as a high molecular weight polyethylene oxide. Other forms of shaving aids include but are not limited to soaps and other lubricating chemistries which can be produced by hot molding, injection molding, extrusion or other processes know in the art.

In the case of a matrix of high molecular weight polyethylene oxide and high impact polystyrene the high impact polystyrene serves as the supporting structure for the lubricating strip and the high molecular weight polyethylene oxide serves as the lubricating component. Examples of suitable lubricating members are described in U.S. Pat. No. 7,811,553; U.S. Publication No. 2008/0060201 A1 published on Mar. 13, 2008; U.S. Publication No. 2009/0223057 A1 published on Sep. 10, 2009; and U.K. Patent No. GB 2138438B.

During shaving the lubricating member undergoes abrasive wear as it slides across the skin. The abrasive wear results in a shape change for the lubricating member. The lubricating member 16 acts as a deformable body on the razor cartridge as its shape changes due to wear.

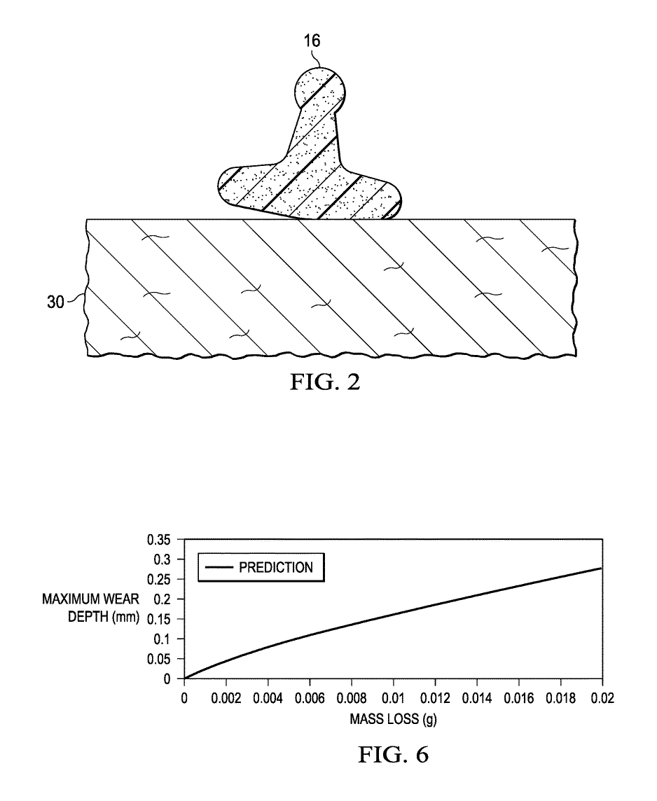

Referring now to FIG. 2, a physical wear measurement determines the mass loss of a lubricating member 16 under a test protocol over a controlled distance d, at a velocity v, and under a normal load force, N, over a deformable substrate 30. While an abrasive felt was chosen for the deformable substrate 30 for testing other deformable substrates may be used. Examples of other deformable substrates include human skin, human skin-like substrates, artificial substrates and other deformable substrates.

The sliding time t is evaluated as the sliding distance divided by the sliding velocity by the following equation: t=d/v. The sliding distance is a finite sliding distance indicating that the lubricating member 16 has a substantial, non-infinitesimal displacement relative to its initial position on the deformable substrate 30.

After taking numerous physical measurements it has been determined that mass loss of a lubricating member proceeds at a nonlinear rate. A prediction of mass loss m is provided by the following variation of Archart's wear law:

m=ρkN(vt)^{b}

where k is a material dependent variable and b is a constant.

The material dependent variable k may be a constant, or a prescribed function of the chemical formulation of the lubricating member. The material dependent variable k may also be a function of the process and process conditions used in making the lubricating member. In the case of a lubricating member composed partially of EVA, the variable k can be described as follows:

k=a₀+a₁X₁+a₂X₂

Where X₁ is the percentage of EVA in the lubricating member, X₂ is the measured molecular weight of polyethylene oxide in the lubricating member, and a₀, a₁, and a₂ are constants to be determined.

For mass loss data {Mᵢ}, i=1, . . . , n, observed at time {tᵢ}, i=1, . . . , n, the material variable k (including constants a₀, a₁, and a2) and constant b are determined by minimization of the sum of squared residuals, SSR, between the mass loss data Mᵢ and the predicted mass loss mᵢ with respect to the constants to be determined wherein

$${m}_{i} = ρ {kN ( {vt}_{i} )}^{b}$$

$$SSR = {\sum }_{i = 1}^{n} {( {M}_{i} - {m}_{i} )}^{2}$$

and ρ is the density of the deformable body. The material dependent variable k may be a constant to be determined, or a prescribed function of the chemical formulation of the lubricating member with constants to be determined. The material dependent variable k may also be a function of the process and process conditions used in making the lubricating member. In the case of a lubricating member composed partially of EVA, the constants a₀, a₁, and a₂ can be determined by a linear fit of the material dependent variable k and formulation inputs X₁ and X₂. The constants a₀, a₁, and a₂ represent the coefficients of this linear fit and can be determined simultaneously with the constant b through minimization of the sum of squared residuals.

The finite element analysis of a deformable body in sliding contact with a deformable substrate in the absence of wear is a standard finite strain contact problem between two deformable bodies as described by Laursen T. A., Computational contact and impact mechanics, Springer, 2003, ISBN 978-3-662-04864-1. This can be implemented in commercial finite element software. The finite element analysis of a deformable body in sliding contact with a deformable substrate using Archard's wear law has been implemented previously, Archard, J. F., Contact and rubbing of flat surfaces, Journal of Applied Physics, 1953. The finite element analysis of a deformable body in sliding contact with a deformable substrate using a nonlinear variant of Archard's wear law is discussed herein.

The worn shape of a lubricating member due to sliding contact with an abrasive substrate is determined by use of commercial finite element software to determine a wear depth w in an inward normal direction at select points on a surface of the deformable body at each point in time t by integration of the following equation:

$$\frac{dw}{d τ} = {kT}_{n} {v}^{b}$$

where k is a material dependent variable, Tₙ is a contact pressure determined by a finite element analysis of the lubricating member in sliding contact with the abrasive felt at each point in time t, v is a sliding velocity between the deformable body and the deformable substrate, b is a constant, and τ=t^{b} is a computational time.

The contact pressure Tₙ is defined as the normal component of contact pressure along the contact surface of the lubricating member during a two-dimensional quasi-static finite element analysis of finite strain frictionless linear elastic contact between the lubricating member and the abrasive felt. An alternative implementation of the virtual wear method is to allow for friction which deforms the substrate tangentially, and hence contact with the lubricating member. Wear may only occur on the contact surface, and therefore the wear depth w is defined to be zero elsewhere.

Referring again to FIG. 2, the model geometry of the lubricating member 16 has two components; a cross-section of a lubricating member 16, and a parameterized section of the substrate 30. The depth in the model is set as 32 mm to match the length of a lubricating member 16.

The stress-strain constitutive relation for the lubricating member and the abrasive felt is linear elasticity. The values of Young's modulus and Poisson's ratio for the lubricating member were determined by physical tests. The value of Young's modulus and Poisson's ratio for the abrasive felt were estimated. In reality, the stress-strain constitutive relation for the lubricating member or the abrasive substrate may be defined by another constitutive relation. The other constitutive relation may be for a different time independent material behavior, such as nonlinear elasticity. This is directly accommodated by the presently described wear algorithm. The invention also extends to time dependent material behavior, such as viscoelasticity, and the necessary modifications to the wear algorithm.

A transformation from time t to computational time τ is necessary when exponent b is less than unity, since the rate of wear depth at t=0 becomes infinite, leading to numerical difficulties. The transformation is expressed as:

τ=t^{b} (0)

The ability to determine the wear rate of a deformable body allows for selection of a desired deformable body to be inserted into a razor blade cartridge. The method of selection of the deformable body is made according to the following steps:
a. selecting a desirable wear rate value for the deformable body,
b. providing a first deformable body,
c. providing a second deformable body different from the first deformable body,
d. determining a wear rate value over a defined period of time of the first deformable body and the second deformable body according to the following method:
   i. determining a wear depth w in an inward normal direction at select points on a surface of the deformable body at each point in time t by integration of the following equation:

$$\frac{dw}{d τ} = {kT}_{n} {v}^{b}$$

where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant, and τ=t^{b} is a computational time,
e. selecting the deformable body from either the first deformable body or the second deformable body having the wear rate value closest to the desirable wear rate value.

After selection, the deformable body such as lubricating member 16 shown in FIG. 1 is secured on a razor cartridge 10. The lubricating member 16 may be secured on the razor cartridge 10 with an adhesive or by mechanical securement, or both.

Computer software may be used to determine the wear rate value of the first and second deformable body.

For mass loss data {Mᵢ}, i=1, . . . , n, observed at time {tᵢ}, i=1, . . . , n, the material variable k and constant b are determined by minimization of the sum of squared residuals, SSR, between the mass loss data Mᵢ and the predicted mass loss mᵢ with respect to the constants to be determined wherein

$${m}_{i} = ρ {kN ( {vt}_{i} )}^{b}$$

$$SSR = {\sum }_{i = 1}^{n} {( {M}_{i} - {m}_{i} )}^{2}$$

and ρ is the density of the deformable body.

The deformable substrate may comprise an abrasive felt, a human skin-like substrate, or a substrate of human skin. The material dependent variable k may be a function of the process used in making the lubricating member.

### Example

The value of the wear test parameters and the material parameters (which are used in the finite element model) are defined in Table 1.

TABLE 1
Wear test parameters and material parameters.

| Parameter | Value | |
|---|---|---|
| Applied load, N, on | 1.962N | |
| lubricating member | | |
| Sliding distance, d | 19.94 | m/min |
| Young's modulus of | 100 | MPa |
| lubricating member | | |
| Poisson's ratio of - | 0.35 | |
| lubricating member | | |
| Density of lubricating | 974 | kg/m³ |
| member, ρ | | |
| Length of lubricating | 32 | mm |
| member | | |
| Young's modulus of | 0.5 | MPa |
| deformable substrate | | |

| | |
|---|---|
| Poisson's ratio of | 0.35 |
| deformable substrate | |

The mass loss data from the wear tests is presented in Table 2. The test materials vary in composition as a result of the experimental levers X₁, X₂, and X₃. Wear tests provide mass loss data for each test material at varying sliding distance. In total, 325 observations of mass loss are recorded in the dataset. The term r denotes the number of repeat cycles over the sliding distance, d.

The functional form of the specific wear rate is prescribed as a linear function of the dependent variables X₁, X₂, and X₃.

k=a₀+a₁X₁+a₂X₂+a₃X₃ (1)

A nonlinear statistical regression is used to fit the coefficients a₀, a₁, a₂, a₃ and b of the modified Archard wear law to the mass loss data. The NonLinearModel. Fit command from the Statistical Toolbox in MATLAB 2013a (MathWorks Inc., Natick, Mass., US), is utilized to estimate values for the model coefficients. This uses the Levenberg-Marquardt algorithm to minimize the nonlinear sum of squared residuals.

TABLE 2
Mass loss data based on experimental levers X₁, X₂, X₃, and the number of revolutions
of the wear wheel.

| X₁ | 23.74 | 23.74 | 31.74 | 39.74 | 39.74 | 19.74 | 23.74 | 19.74 | 23.74 | 31.74 | 23.74 | 39.74 | 39.74 |
|---|---|---|---|---|---|---|---|---|---|---|---|---|---|
| X₂ | 0 | 0 | 0 | 0 | 0 | 0 | 0 | 1 | 1 | 1 | 1 | 1 | 1 |
| X₃ | 1.75 | 4.51 | 2.75 | 2.00 | 4.83 | 2.57 | 2.70 | 2.58 | 1.67 | 2.75 | 4.37 | 1.92 | 4.36 |
| | Mass loss (g) | | | | | | | | | | | | |
| 5 | 0.0022 | 0.0013 | 0.0016 | 0.0014 | 0.0010 | 0.0023 | 0.0021 | 0.0025 | 0.0021 | 0.0020 | 0.0019 | 0.0017 | 0.0007 |
| 5 | 0.0023 | 0.0014 | 0.0018 | 0 0013 | 0.0010 | 0.0024 | 0.0023 | 0.0026 | 0.0022 | 0.0020 | 0.0019 | 0.0011 | 0.0011 |
| 5 | 0.0020 | 0.0016 | 0.0014 | 0.0011 | 0.0011 | 0.0024 | 0.0024 | 0.0026 | 0.0023 | 0.0018 | 0.0018 | 0.0015 | 0.0006 |
| 5 | 0.0022 | 0.0015 | 0.0017 | 0.0014 | 0.0008 | 0.0023 | 0.0023 | 0.0023 | 0.0023 | 0.0021 | 0.0020 | 0.0014 | 0.0011 |
| 5 | 0.0023 | 0.0016 | 0.0016 | 0.0015 | 0.0009 | 0.0026 | 0.0022 | 0.0024 | 0.0020 | 0.0019 | 0.0019 | 0.0016 | 0.0010 |
| 10 | 0.0033 | 0.0022 | 0.0024 | 0.0019 | 0.0013 | 0.0038 | 0.0034 | 0.0033 | 0.0031 | 0.0027 | 0.0027 | 0.0018 | 0.0013 |
| 10 | 0.0034 | 0.0024 | 0.0026 | 0.0021 | 0.0015 | 0.0037 | 0.0031 | 0.0038 | 0.0031 | 0.0030 | 0.0030 | 0.0020 | 0.0015 |
| 10 | 0.0034 | 0.0019 | 0.0024 | 0.0020 | 0.0016 | 0.0036 | 0.0033 | 0.0038 | 0.0031 | 0.0031 | 0.0028 | 0.0022 | 0.0014 |
| 10 | 0.0033 | 0.0020 | 0.0024 | 0.0020 | 0.0015 | 0.0038 | 0.0035 | 0.0033 | 0.0033 | 0.0029 | 0.0028 | 0.0020 | 0.0009 |
| 10 | 0.0034 | 0.0025 | 0.0024 | 0.0019 | 0.0016 | 0.0038 | 0.0033 | 0.0038 | 0.0031 | 0.0030 | 0.0031 | 0.0019 | 0.0015 |
| 15 | 0.0045 | 0.0026 | 0.0031 | 0.0024 | 0.0021 | 0.0046 | 0.0044 | 0.0048 | 0.0045 | 0.0036 | 0.0032 | 0.0025 | 0.0018 |
| 15 | 0.0042 | 0.0024 | 0.0028 | 0.0026 | 0.0019 | 0.0047 | 0.0043 | 0.0045 | 0.0043 | 0.0035 | 0.0037 | 0.0022 | 0.0016 |
| 15 | 0.0044 | 0.0028 | 0.0031 | 0.0025 | 0.0018 | 0.0045 | 0.0045 | 0.0048 | 0.0043 | 0.0036 | 0.0037 | 0.0023 | 0.0019 |
| 15 | 0.0045 | 0.0033 | 0.0032 | 0.0026 | 0.0018 | 0.0049 | 0.0043 | 0.0051 | 0.0045 | 0.0033 | 0.0036 | 0.0022 | 0.0016 |
| 15 | 0.0047 | 0.0028 | 0.0030 | 0.0024 | 0.0018 | 0.0050 | 0.0045 | 0.0048 | 0.0042 | 0.0037 | 0.0037 | 0.0024 | 0.0019 |
| 25 | 0.0058 | 0.0043 | 0.0042 | 0.0034 | 0.0028 | 0.0063 | 0.0057 | 0.0064 | 0.0057 | 0.0046 | 0.0053 | 0.0031 | 0.0024 |
| 25 | 0.0061 | 0.0042 | 0.0042 | 0.0035 | 0.0028 | 0.0067 | 0.0056 | 0.0064 | 0.0055 | 0.0048 | 0.0048 | 0.0026 | 0.0025 |
| 25 | 0.0059 | 0.0038 | 0.0042 | 0.0032 | 0.0026 | 0.0067 | 0.0058 | 0.0068 | 0.0061 | 0.0048 | 0.0052 | 0.0034 | 0.0025 |
| 25 | 0.0057 | 0.0044 | 0.0044 | 0.0034 | 0.0029 | 0.0066 | 0.0055 | 0.0065 | 0.0060 | 0.0048 | 0.0049 | 0.0034 | 0.0022 |
| 25 | 0.0059 | 0.0038 | 0.0043 | 0.0033 | 0.0026 | 0.0067 | 0.0057 | 0.0063 | 0.0062 | 0.0046 | 0.0051 | 0.0030 | 0.0024 |
| 50 | 0.0092 | 0.0072 | 0.0066 | 0.0048 | 0.0040 | 0.0101 | 0.0086 | 0.0097 | 0.0089 | 0.0072 | 0.0079 | 0.0044 | 0.0037 |
| 50 | 0.0086 | 0.0064 | 0.0062 | 0.0050 | 0.0041 | 0.0095 | 0.0083 | 0.0101 | 0.0092 | 0.0071 | 0.0076 | 0.0045 | 0.0037 |
| 50 | 0.0086 | 0.0064 | 0.0067 | 0.0047 | 0.0043 | 0.0092 | 0.0087 | 0.0099 | 0.0089 | 0.0070 | 0.0076 | 0.0048 | 0.0038 |
| 50 | 0.0087 | 0.0060 | 0.0061 | 0.0047 | 0.0040 | 0.0093 | 0.0081 | 0.0107 | 0.0085 | 0.0070 | 0.0081 | 0.0043 | 0.0034 |
| 50 | 0.0088 | 0.0066 | 0.0065 | 0.0049 | 0.0042 | 0.0093 | 0.0088 | 0.0095 | 0.0086 | 0.0072 | 0.0080 | 0.0044 | 0.0038 |

Table 3 contains the coefficient values for the mass loss dataset, fitted using nonlinear regression. Dependent variables X₁ and X₃ are significant at the 95% level. (Precisely, the specific wear rate decreases with an increase in either of the experimental levers X₁ and X₃.) Dependent variable X₂ is deemed insignificant at the 95% level, and as such is excluded from further analysis. The nonlinear regression is therefore fitted using experimental levers X₁ and X₃ only.

TABLE 3
Coefficient values fitted using nonlinear
regression for the mass loss dataset.

| Coefficient | Fitted value |
|---|---|
| a₀ | 0.89799 |
| a₁ | −0.01356 |
| a₂ | 0 |
| a₃ | −0.03249 |
| b | 0.59699 |

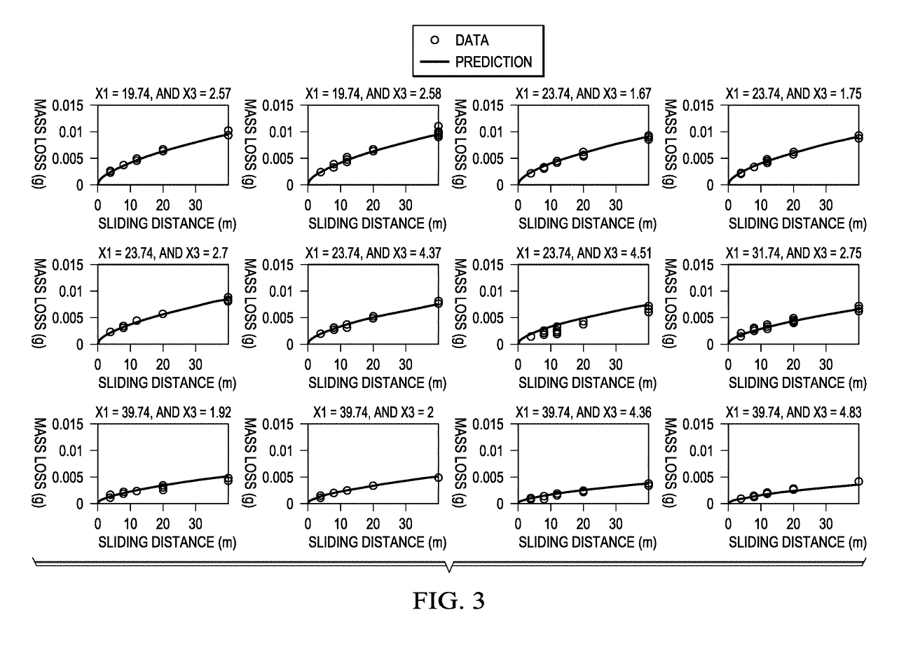

The fitted model provides an exceptional prediction of mass loss (R²=0.975) based on 325 observations. The mass loss predictions for each test material are plotted against raw mass loss data in FIG. 3.

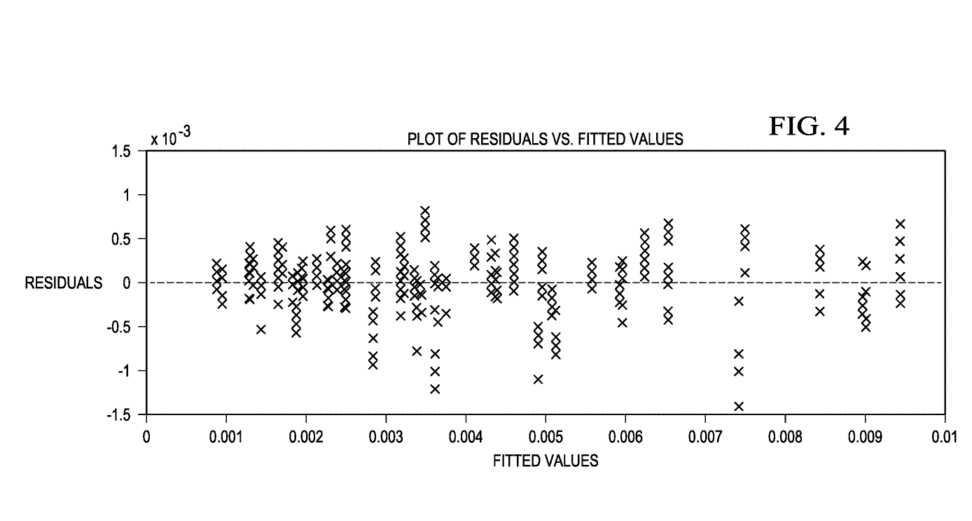

To examine the variation between the model predictions and the raw data, FIG. 4 plots the residuals (between the fitted model and the raw data) against the fitted values. The residual plot suggests no trend, inferring that the variation between the fitted model and the raw data is random. There are no significant outliers.

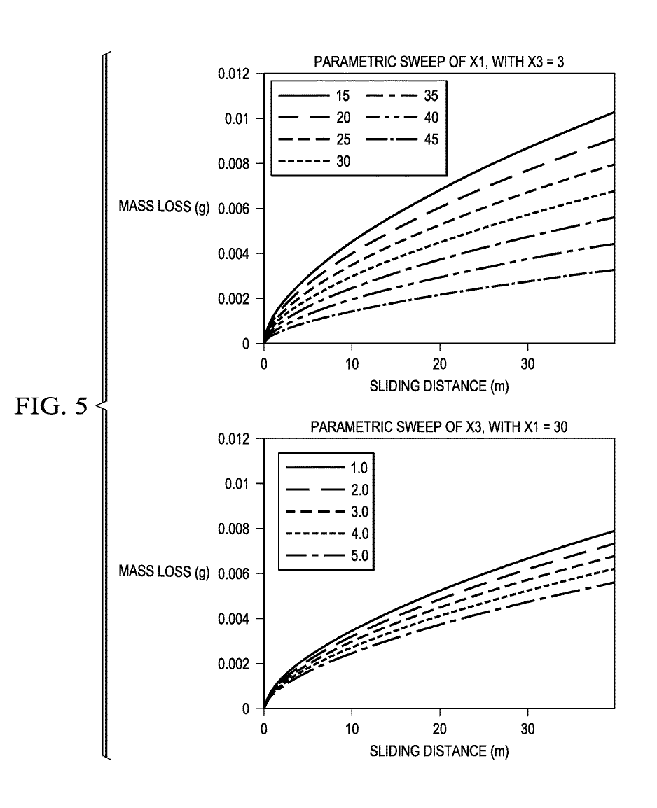

FIG. 5 shows how the prediction of mass loss varies due to changes in the dependent variables X₁ and X₃. The predicted mass loss is plotted against sliding distance in FIG. 5 (left), across a wide range of values of X₁ and for a fixed value of X₃. Similarly, FIG. 5 (right), shows the mass loss predictions across a wide range of values of X₃ for a fixed value of X₁. Variations in experimental lever X₁ have a larger effect on mass loss predictions than variations in experimental lever X₃.

The simulation of wear provides a one-to-one relationship between mass loss and shape change. That is to say, a known mass loss (provided by nonlinear regression) has a unique maximum wear depth, regardless of the value of the dependent variables X₁, X₃, and d. Therefore only one finite element analysis is required, with a sufficiently large mass loss. The finite element analysis of wear, using a mass loss of 0.020 g, and 10197 degrees of freedom, solves in 22 minutes. Temporal integration requires 512 time-steps, with the maximum computational time-step set as 0.002 s. The final prediction of mass loss is 0.01994 g, where the 0.3% error is a result of the spatial discretisation of the geometry into a finite element mesh.

FIG. 6 shows mass loss plotted against maximum wear depth, and is directly obtained from the finite element analysis of wear. This curve is invariant to changes in sliding distance or the experimental levers X₁ and X₃, and is a vital tool which provides a prediction of maximum wear depth for any mass loss.

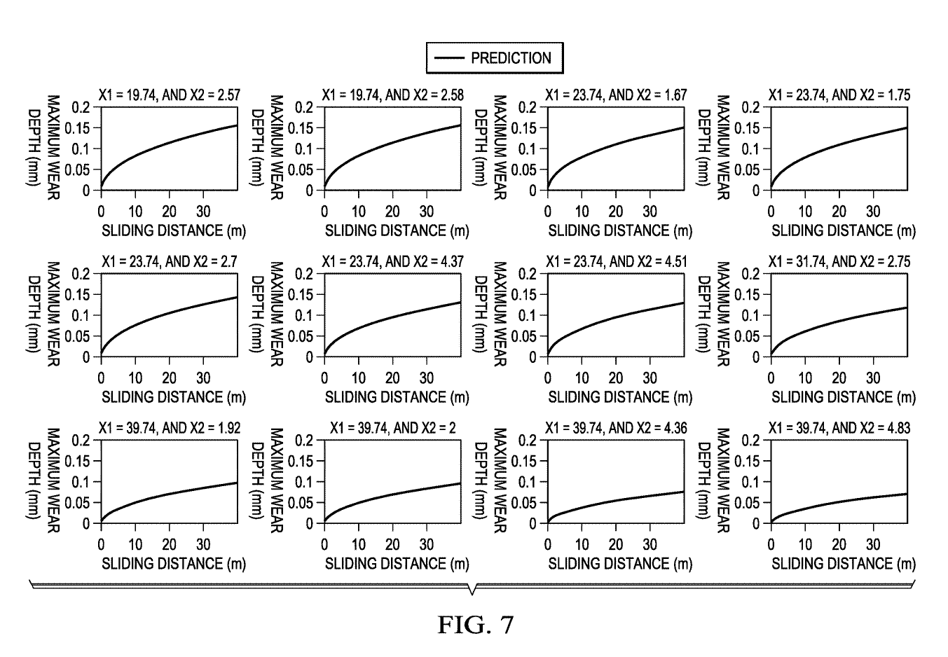

The maximum wear depth predictions for each test material are plotted in FIG. 7.

Regarding all numerical ranges disclosed herein, it should be understood that every maximum numerical limitation given throughout this specification includes every lower numerical limitation given throughout this specification includes every lower numerical limitation, as if such lower numerical limitations were expressly written herein. In addition, every minimum numerical limitation given throughout this specification will include every higher numerical limitation, as if such higher numerical limitations were expressly written herein. Further, every numerical range given throughout this specification will include every narrower numerical range given throughout this specification will include every narrower numerical range that falls within such broader numerical range and will also encompass each individual number within the numerical range, as if such narrower numerical ranges and individual numbers were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for determining the worn shape of a deformable body in sliding contact with a deformable substrate comprising: determining a wear depth w in an inward normal direction at select points on a surface of the deformable body at each point in time t by integration of the following equation:
$$\frac{dw}{d τ} = {kT}_{n} {v}^{b}$$
where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant, and τ=t^{b} is a computational time.

2. The method of claim 1 wherein computer software is used to determine the worn shape of the deformable body.

3. The method of claim 1 wherein for mass loss data {Mᵢ}, i=1, . . . , n, observed at time {tᵢ}, i=1, . . . , n, the material variable k and constant b are determined by minimization of the sum of squared residuals, SSR, between the mass loss data Mᵢ and the predicted mass loss mᵢ with respect to the constants to be determined wherein
$${m}_{i} = ρ {kN ( {vt}_{i} )}^{b}$$
$$SSR = {\sum }_{i = 1}^{n} {( {M}_{i} - {m}_{i} )}^{2}$$
and ρ is the density of the deformable body.

4. The method of claim 1 wherein the deformable substrate comprises an abrasive felt.

5. The method of claim 1 wherein the deformable substrate comprises a human skin-like substrate.

6. The method of claim 1 wherein the deformable substrate comprises a substrate of human skin.

7. The method of claim 1 wherein the deformable body comprises a lubricating member on a razor cartridge.

8. The method of claim 1 wherein the material dependent variable k is a function of the process used in making the lubricating member.

9. The method of claim 8 wherein the material dependent variable k is a function of the process conditions used in making the lubricating member.

10. The method of claim 1 wherein the material dependent variable k is a function of the chemical formulation of the lubricating member.

11. The method of claim 1 wherein the sliding contact is a finite sliding contact.

12. A method for selecting a deformable body to be inserted into a razor blade cartridge, said method comprising the steps of:
a. selecting a desirable wear rate value for the deformable body,
b. providing a first deformable body,
c. providing a second deformable body different from the first deformable body,
d. determining a wear rate value over a defined period of time of the first deformable body and the second deformable body according to the following method:
i. determining a wear depth w in an inward normal direction at select points on a surface of the deformable body at each point in time t by integration of the following equation:
$$\frac{dw}{d τ} = {kT}_{n} {v}^{b}$$
where k is a material dependent variable determined by physical tests, Tₙ is a contact pressure determined by finite element analysis of the deformable body in sliding contact with the deformable substrate at each point in time t, v is a constant sliding velocity between the deformable body and the deformable substrate, b is a constant, and τ=t^{b} is a computational time,
e. selecting the deformable body from either the first deformable body or the second deformable body having the wear rate value closest to the desirable wear rate value.

13. The method of claim 12 wherein the deformable body is secured on a razor cartridge.

14. The method of claim 12 wherein computer software is used to determine the wear rate value of the first and second deformable body.

15. The method of claim 12 wherein for mass loss data {Mᵢ}, i=1, . . . , n, observed at time {tᵢ}, i=1, . . . , n, the material variable k and constant b are determined by minimization of the sum of squared residuals, SSR, between the mass loss data Mᵢ and the predicted mass loss mᵢ with respect to the constants to be determined wherein
$${m}_{i} = ρ {kN ( {vt}_{i} )}^{b}$$
$$SSR = {\sum }_{i = 1}^{n} {( {M}_{i} - {m}_{i} )}^{2}$$
and ρ is the density of the deformable body.

16. The method of claim 12 wherein the deformable substrate comprises an abrasive felt.

17. The method of claim 12 wherein the deformable substrate comprises a human skin-like substrate.

18. The method of claim 13 wherein the deformable body is secured on the razor cartridge with an adhesive.

19. The method of claim 13 wherein the deformable body is secured on the razor cartridge with mechanical securement.

20. The method of claim 12 wherein the material dependent variable k is a function of the process used in making the lubricating member.
